(19) United States
(12) Patent Application Publication
(10) Pub. No.: US 2011/0219392 A1
(43) Pub. Date: Sep. 8, 2011

(54) INTEGRATED DISK DRIVING MODULE

(75) Inventors: Hoeop Yoon, Seoul (KR); Sejong Kim, Seoul (KR); Jeongho Lee, Seoul (KR)

(73) Assignee: LG Innotek Co., Ltd., Seoul (KR)

(21) Appl. No.: 13/038,898

(22) Filed: Mar. 2, 2011

(30) Foreign Application Priority Data
Mar. 5, 2010 (KR) 10-2010-0019797

(51) Int. Cl. G11B 19/20; G11B 7/08

(52) U.S. Cl. 720/663; 720/697; G9B/7.041; G9B/19.027

(57) ABSTRACT

An integrated disk driving module is disclosed, the module including a base unit formed with a first motor fixture concavely formed on an upper plate, and a second motor fixture bent from the upper plate in opposition to the first motor fixture, wherein the first and second motor fixtures are integrally formed on the upper plate; a spindle motor secured inside the first motor fixture to rotate a disk; and a stepping motor rotatably secured to the second motor fixture.

### CROSS-REFERENCE TO RELATED APPLICATION

This application claims the benefit under 35 U.S.C. §119 of Korean Application No. 10-2010-0019797, filed Mar. 5, 2010, which is hereby incorporated by reference in its entirety.

### BACKGROUND OF THE DISCLOSURE

1Field of the Invention

The present disclosure relates to an integrated disk driving module.

2. Description of Related Art

In general, an ODD (Optical Disk Driver) stores huge data on a disk, and reads the data stored in the disk.

The ODD largely includes a base body, a spindle motor coupled to the base body via a coupling screw, a stepping motor coupled to the base body via a coupling screw, and an optical pickup module storing data on a disk or reading the data from the disk.

The spindle motor is coupled to the base body via a mounting plate, and rotates an optical disk for storing data or an optical disk stored with data at a high speed.

The stepping motor is coupled to the base body via a mounting plate, and feeds the optical pickup module to a radial direction of the optical disk.

The optical pickup module is coupled to a guide shaft coupled to the base body via a coupling screw and slides along the guide shaft by rotation of a lead screw of the stepping motor. The optical pickup module slides along the guide shaft to store data on the optical disk and reads the data stored in the optical disk.

A stepping motor and a spindle motor of an optical disk apparatus according to prior art are respectively coupled to a base body via a mounting plate and coupling screws to the disadvantage of increasing the number of parts comprising the optical disk apparatus.

The conventional optical disk apparatus is also disadvantageous in that the number of parts increases to take many hours for assembly. The conventional optical disk apparatus is further disadvantageous in that product features of the optical disk apparatus decreases due to manufacturing tolerances of the base body and the stepping motor.

The conventional optical disk apparatus is still further disadvantageous in that the stepping motor and the spindle motor are coupled to the base body to result in frequent bad assembly in which the stepping motor is not mounted at a designated position, and a lead screw of the stepping motor and a guide shaft of the optical pickup module are not aligned in parallel.

The conventional optical disk apparatus is still further disadvantageous in that a mounting plate for coupling the spindle motor to the base body is needed to increase size and weight of the optical disk apparatus and to be prone to external shock.

### BRIEF SUMMARY The present disclosure is to provide an integrated disk driving module configured to reduce the number of parts by integrally forming a stepping motor and a spindle motor to a base unit, to reduce the number of parts, to reduce assembly time as a result of reduced number of parts, to improve product performance as a result of reduced assembly tolerances, to inhibit incomplete assembly by arranging the spindle motor and the stepping motor at a designated position and to reduce size and weight.

An object of the present disclosure is to solve at least one or more of the above problems and/or disadvantages in whole or in part and to provide at least the advantages described hereinafter. In order to achieve at least the above object, in whole or in part, and in accordance with the purpose of the invention, as embodied and broadly described, and in one general aspect of the present disclosure, there is provided an integrated disk driving module, the module comprising: a base unit including a first motor fixture concavely formed on an upper plate, and a second motor fixture bent from the upper plate in opposition to the first motor fixture, wherein the first and second motor fixtures are integrally formed on the upper plate; a spindle motor secured inside the first motor fixture to rotate a disk; and a stepping motor rotatably secured to the second motor fixture.

Technical problems to be solved by the present disclosure are not restricted to the above-mentioned, and any other technical problems not mentioned so far will be clearly appreciated from the following description by those skilled in the art.

### BRIEF DESCRIPTION OF DRAWINGS

FIG. 1 is a rear perspective view of an integrated disk driving module according to an exemplary embodiment of the present invention.

FIG. 2 is a front perspective view of a base unit of FIG. 1.

FIG. 3 is a rear perspective view of a base unit of FIG. 1.

FIG. 4a is an exploded perspective view of a base unit and a spindle motor of FIG. 2.

FIG. 4b is a perspective view illustrating a spindle motor of an integrated driving module and a floor unit of a first motor driving unit of a base unit according to another exemplary embodiment of the present disclosure.

FIG. 5 is an exploded perspective view illustrating a stepping motor coupled to the base unit of FIG. 3.

FIG. 6 is a partially enlarged view of ‘A’ of FIG. 1.

### DETAILED DESCRIPTION

The following description is not intended to limit the invention to the form disclosed herein. Consequently, variations and modifications commensurate with the following teachings, and skill and knowledge of the relevant art are within the scope of the present invention. The embodiments described herein are further intended to explain modes known of practicing the invention and to enable others skilled in the art to utilize the invention in such, or other embodiments and with various modifications required by the particular application(s) or use(s) of the present invention.

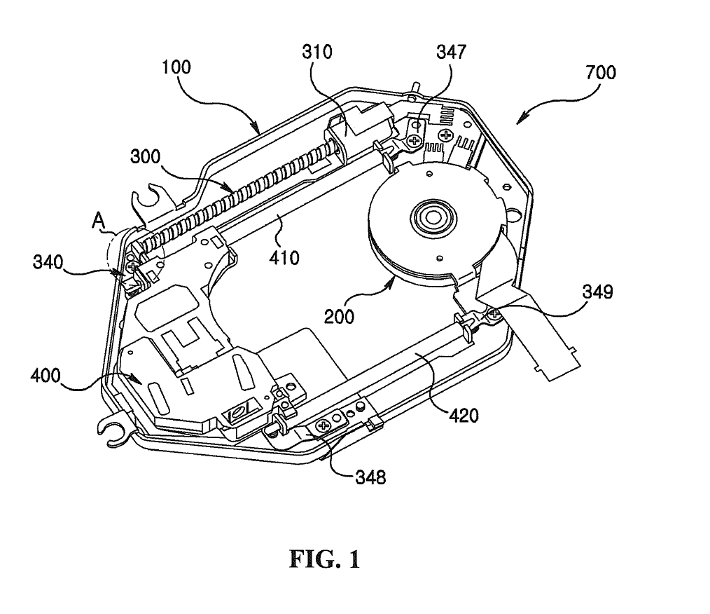

The disclosed embodiments and advantages thereof are best understood by referring to FIGS. 1-6 of the drawings, like numerals being used for like and corresponding parts of the various drawings. Other features and advantages of the disclosed embodiments will be or will become apparent to one of ordinary skill in the art upon examination of the following figures and detailed description. It is intended that all such additional features and advantages be included within the scope of the disclosed embodiments, and protected by the accompanying drawings. Further, the illustrated figures are only exemplary and not intended to assert or imply any limitation with regard to the environment, architecture, or process in which different embodiments may be implemented. Accordingly, the described aspect is intended to embrace all such alterations, modifications, and variations that fall within the scope and novel idea of the present invention.

It will be understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. That is, the terms “including”, “includes”, “having”, “has”, “with”, or variants thereof are used in the detailed description and/or the claims to denote non-exhaustive inclusion in a manner similar to the term “comprising”.

Furthermore, “exemplary” is merely meant to mean an example, rather than the best. It is also to be appreciated that features, layers and/or elements depicted herein are illustrated with particular dimensions and/or orientations relative to one another for purposes of simplicity and ease of understanding, and that the actual dimensions and/or orientations may differ substantially from that illustrated. That is, in the drawings, the size and relative sizes of layers, regions and/or other elements may be exaggerated or reduced for clarity. Like numbers refer to like elements throughout and explanations that duplicate one another will be omitted. Now, the present invention will be described in detail with reference to the accompanying drawings.

### First Exemplary Embodiment

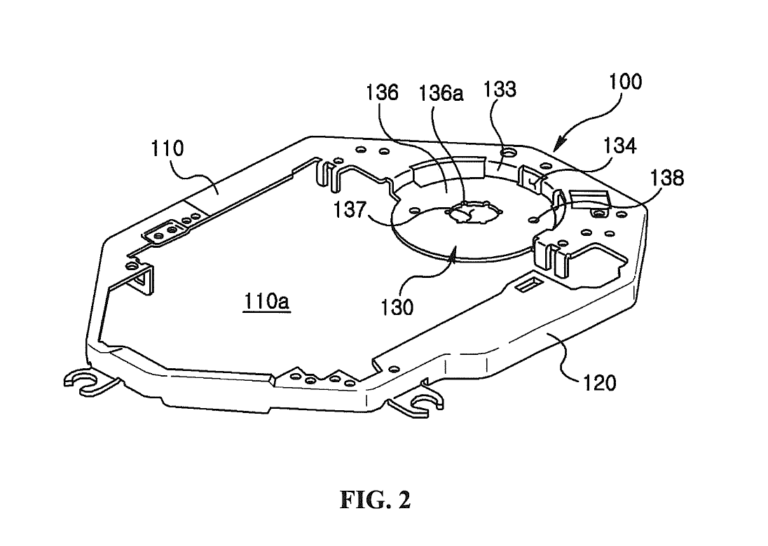

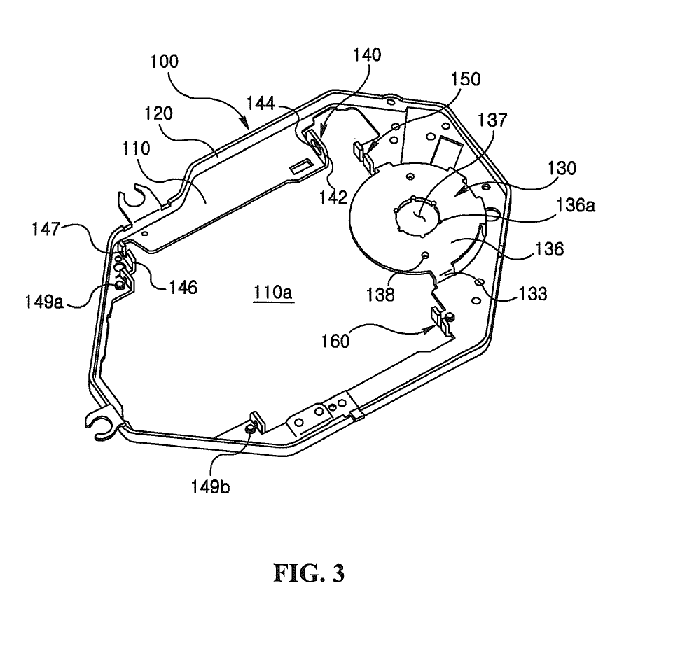

FIG. 1 is a rear perspective view of an integrated disk driving module according to an exemplary embodiment of the present invention, FIG. 2 is a front perspective view of a base unit of FIG. 1 and FIG. 3 is a rear perspective view of a base unit of FIG. 1.

Referring to FIG. 1, an integrated disk driving module (700) may include a base unit (100), a spindle motor (200) and a stepping motor (300). The integrated disk driving module (700) may further include an optical pickup module (400).

Referring to FIGS. 2 and 3, the base unit (100) includes an upper plate (110), a lateral surface plate (120) and a first motor fixture (130) and a second motor fixture (140). The base unit (100) may further include first and second guide shaft fixtures (150, 160).

The upper plate (110) includes a metal plate, and is centrally formed with an accommodation space (110a).

The accommodation space (110a)-formed upper plate (110) may take the shape of an octagonal plate when viewed from a plane. Although the present exemplary embodiment of the present disclosure describes the upper plate (110) of an octagonal plate, the shape of the upper plate (110) may take various shapes based on arrangement and shape of the spindle motor (200, described later), the stepping motor (300) and the optical pickup module (400).

The lateral surface plate (120) is bent from an edge of the upper plate (110) to one lateral direction of the upper plate (110), and an accommodation space is formed at the base unit (100) by the upper plate (110) and the lateral surface plate (120). In the present exemplary embodiment, the lateral surface plate (120) is perpendicularly formed relative to the upper plate (110), for example.

The first motor fixture (130) is formed in the shape of a recess from the upper plate (110) toward the accommodation space. In the present exemplary embodiment, the first motor fixture (130) is integrally formed with the upper plate (110).

The recess-shaped first motor fixture (130) includes a lateral wall unit (133) and a floor unit (136), and the lateral wall unit (133) and the floor unit (136) are integrally formed with the upper plate (110).

The lateral wall unit (133) is bent to the same bent direction as that of the lateral surface plate (120) from the upper plate (110), and the lateral wall unit (133) may be arranged in parallel with the lateral surface plate (120), for example. That is, the lateral wall unit (133) is perpendicularly arranged to the upper plate (110), for example.

The lateral wall unit (133) bent from the upper plate (110) is formed with at least one opening (134), and three openings (134) may be formed from the lateral wall unit (133), for example. Each of the three openings (134) may have a same size or a different size from the other.

The opening (134) formed at the lateral wall unit (133) is passed by a circuit substrate (180, described later) electrically connected to the spindle motor (200, described later). Furthermore, the integrated disk driving module (700) can have a lighter weight by the openings (134) formed at the lateral wall unit (133).

The floor unit (136) is integrally formed with the lateral wall unit (133) and is arranged in parallel with the upper plate (110), for example. In the present exemplary embodiment, the floor unit (136) takes the shape corresponding to that of the spindle motor (200, described later). For example, the floor unit (136) takes the shape of a disk when viewed from a plane. Although the present exemplary embodiment has described and illustrated the floor unit (136) as having the shape of a disk, the floor unit (136) may alternatively take other shapes than the disk.

A center of the floor unit (136) is formed with a round through hole (137) when viewed on a plane. The through hole (137) centrally formed at the floor unit (136) is coupled by a bearing housing (139) securing the spindle motor (200, described later) to the floor unit (136) and fixing a bearing and a rotation shaft of the spindle motor (200).

Referring to FIG. 3, an inner lateral surface of the floor unit (136) formed by the through hole (137) formed at the center of the floor unit (136) is formed with an internal rotation prevention groove (136a) concavely formed from the inner lateral surface to inhibit the bearing housing of the spindle motor (200) from rotating relative to the floor unit (136).

At least one alignment hole (138) is formed about the through hole (137) formed at the center of the floor unit (136). The alignment hole (138) functions to align a circuit substrate (180, described later) interposed between the floor unit (136) and the spindle motor (200) arranged on the floor unit (136) on a designated position of the floor unit (136). The alignment hole (138) penetrates an upper surface on which the spindle motor (200) is disposed and a bottom surface facing the upper surface on the floor unit (136).

Referring to FIG. 3 again, the second motor fixture (140) is formed at one lateral surface of the first motor fixture (130), and secures the stepping motor (300, described later) to the base unit (100). In the present exemplary embodiment, the second motor fixture (140) is integrally formed with the upper plate (110).

The second motor fixture (140) integrally formed with the upper plate (110) is bent from the upper plate (110) to the accommodation space (110a) in a pair, and each of the bent pair of second motor fixtures (140) faces the other second motor fixture (140) inside the accommodation space (110a).

The oppositely faced pair of second motor fixtures (140) is defined as a first fixture (142) and a second fixture (146), and the first and second fixtures (142, 146) are formed in parallel on the upper plate (110).

The first fixture (142) is bent from the upper plate (110) toward the accommodation space (110a), and perpendicularly bent to the upper plate (110), for example.

The first fixture (142) is centrally formed with a round through hole (144). The through hole (144) formed at the first fixture (142) may alternatively take the shape of an oblong or slit in addition to the round shape. The through hole (144) of the first fixture (142) is passed by a lead screw which is a part of the stepping motor (300, described later), whereby one lateral unit of the lead screw is rotatably supported by the first fixture (142).

The second fixture (146) facing the first fixture (142) is bent from the upper plate (110) toward the accommodation space (110a), and is perpendicularly bent to the upper plate (110), for example.

An upper surface of the second fixture (146) bent from the upper plate (110) is formed with an insertion groove (147) concavely formed from an upper surface of the second fixture (146) toward a bottom surface facing an upper surface. The insertion groove (147) formed at the second fixture (146) rotatably supports the other lateral surface facing the one lateral surface of the lead screw which is a part of the stepping motor (300, described later).

Although the present exemplary embodiment has described and illustrated that the first fixture (142) is formed with the through hole (144) and the second fixture (146) is formed with the insertion groove (147), it should be apparent that each of the first and second fixtures (142, 146) may be alternatively formed with an insertion groove, and each of the first and second fixtures (142, 146) may be formed with a through hole.

The first and second fixtures (142, 146) illustrated in FIG. 3 may be oppositely arranged. Referring to FIG. 3 again, the upper plate (110) is formed with a first guide shaft fixture (150) and a second guide shaft fixture (160) to secure first and second guide shafts (described later). Each of the first and second guide shaft fixtures (150, 160) is formed at each side of the first motor fixture (130).

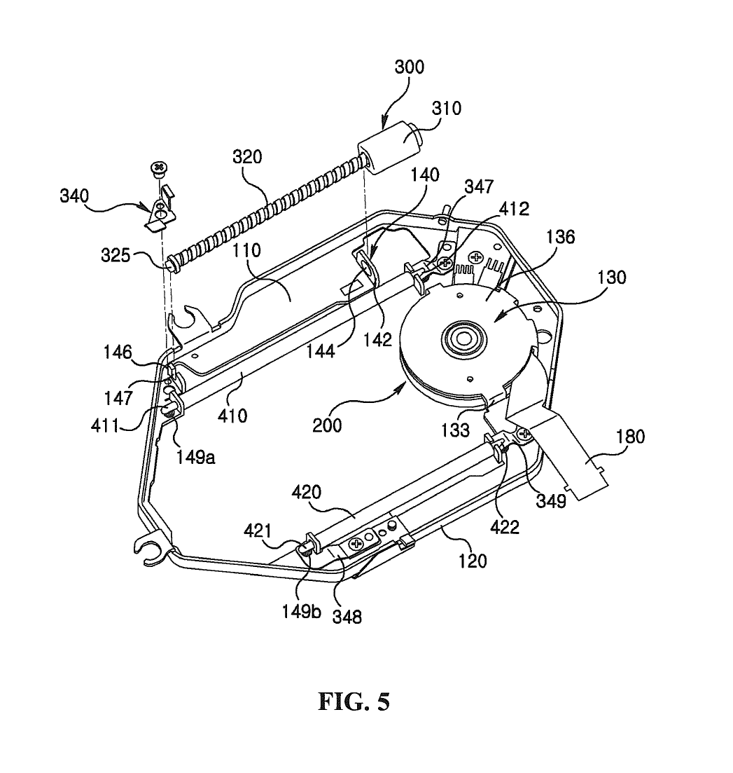

The first guide shaft fixture (150) is integrally formed with the upper plate (110) of the base unit (100), and functions to secure a first guide shaft (410, see FIG. 5) of the optical pickup module (400, described later) to the base unit (100).

The first guide shaft fixture (150) is formed in a pair on the upper plate (110), each facing the other fixture, and each of the pair of first guide shaft fixtures (150) is bent from the upper plate (110) toward the accommodation space (110a). The first guide shaft fixtures (150) are arranged in parallel with the first and second fixtures (142, 146) of the second motor fixture (140).

The first guide shaft fixture (150) arranged near to the first fixture (142) of the second motor fixture (140) is formed with an insertion groove in which a first distal end of the first guide shaft (described later) is inserted, and the remaining another first guide shaft fixture (150) arranged near to the second fixture (146) of the second motor fixture (140) is formed with a through hole through which a second distal end facing the first distal end of the first guide shaft (410, described later) passes. In the present exemplary embodiment, the through hole through which the second distal end of the first guide shaft (410) passes may take the shape of an oblong or a slit.

Furthermore, a coupling hole is formed at each position facing the first guide shaft protruded outside of each of the first guide shaft fixtures (150) on the upper plate (110), and each coupling hole is formed with a height adjustment screw (149a). The height adjustment screw (149a) adjusts a height of the first guide shaft (410) relative to the upper plate (110). The second guide shaft fixture (160) arranged in parallel with the first guide shaft fixture (150) is formed at the upper plate (110) of the base unit (100), and functions to secure a second guide shaft (420, described later and see FIG. 5) to the upper plate (110) of the base unit (100).

The second guide shaft fixture (160) is arranged on the upper plate (110) in a pair, each facing the other, and each of the pair of second guide shaft fixtures (160) is bent from the upper plate (110) toward the accommodation space. The second guide shaft fixture (160) is arranged in parallel with the first and second fixtures (142, 146) of the second motor fixtures (140).

One of the pair of second guide shaft fixtures (160) is formed with an insertion groove through which a third distal end of the second guide shaft (420, described later) is inserted. The remaining one of the pair of second guide shaft fixtures (160) is formed with a through hole through which a fourth distal end facing the third distal end of the second guide shaft (420, described later) passes.

In the present exemplary embodiment, the through hole for passing the fourth distal end of the second guide shaft (420) may take the shape of an oblong or a slit.

Coupling holes are formed at positions facing the second guide shaft (420) protruded outside of the second guide shaft fixtures (160) on the upper plate (110) of the base unit (100), where each of the coupling holes is formed with a height adjustment screw (149b). The height adjustment screw (149b) adjusts a height between second guide shaft (420) and the upper surface (110).

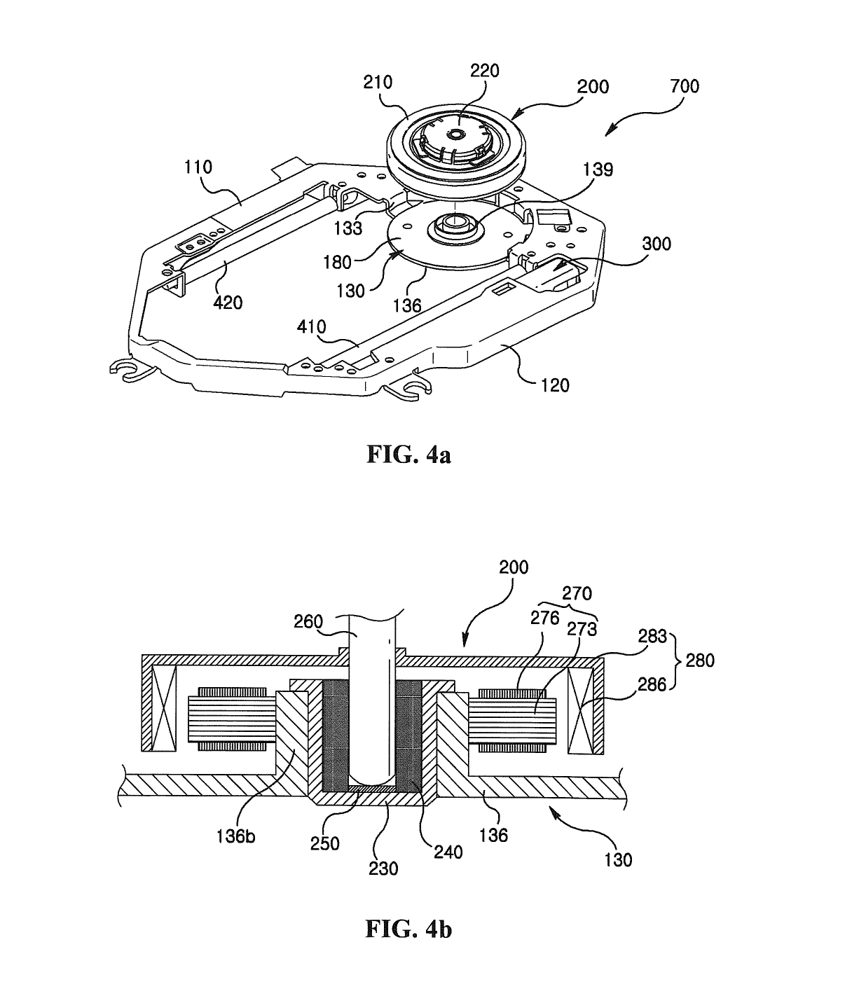

FIG. 4a is an exploded perspective view of a base unit and a spindle motor of FIG. 2. Referring to FIGS. 1 and 4a, the spindle motor (200) is arranged inside the first motor fixture (130) concavely formed from the upper plate (110) of the base unit (100).

The spindle motor (200) includes a bearing housing (139), a stator (not shown) secured at the bearing housing (139) and a rotor (210) rotating in association with the stator coupled to a rotation shaft (not shown) coupled to the bearing housing (139). The spindle motor (200) may further include a disk fixture device (220) coupled to the rotation shaft for securing a disk.

The bearing housing (139) is coupled to a through hole (137) formed at the floor unit (136) of the spindle motor fixture (130) bent from the upper plate (110) of the base unit (100). The bearing housing (139) includes a bearing (not shown).

In the present exemplary embodiment, the floor unit (136) of the spindle motor fixture (130) functions as a mounting plate coupled to the spindle motor of prior art via a coupling screw. In the present exemplary embodiment, configuration of the spindle motor (200) is not limited thereto, but may include other various constituent elements or may delete some of the above- mentioned configurations.

The disk fixture device (220) is rotated along with a rotation shaft by being coupled to the rotation shaft of the spindle motor (200), and is coupled with an optical disk for storing data or an optical disk for reading the stored data.

The spindle motor (200) is arranged with a thin circuit substrate (180) that is applied with a driving signal for driving the spindle motor (200). In the present exemplary embodiment, the circuit substrate (180) may be a flexible circuit substrate.

Part of the circuit substrate (180) is interposed between the spindle motor (200) and the floor unit (136) of the spindle motor fixture (130), and is extracted outside of the spindle motor fixture (130) through an opening (134) formed at the lateral wall unit (133) of the first motor fixture (130).

FIG. 4b is a perspective view illustrating a spindle motor of an integrated driving module and a floor unit of a spindle motor fixture of a base unit according to another exemplary embodiment of the present disclosure.

Referring to FIG. 4b, the floor unit (136) of the first motor fixture (130) of the base unit (100) according to another exemplary embodiment of the present disclosure is formed with a cylindrical burring unit (136b) protruded toward an upper surface facing a bottom surface from the bottom surface of the floor unit (136).

The burring unit (136b) is formed therein with an upper surface-opened bottom-closed cup-shaped bearing housing (230), and the bearing housing (230) is coupled therein by a cylindrical bearing (240). The bearing (240) coupled to the bearing housing (230) is rotatably coupled by a rotation shaft (260) relative to the bearing (240). Reference numeral 250 is a thrust bearing interposed between the rotation shaft (260) and the housing (230).

The burring unit (136b) is formed at a periphery thereof with a stator (270). The stator (270) includes a core (273) formed by stacking a plurality of iron pieces, and a coil (276) wound on the core (273).

The rotation shaft (260) is formed at a periphery thereof with a rotor (280). The rotor (280) includes a yoke (283) and a magnet (286), where the yoke (283) is coupled to the rotation shaft (260), and a part of the yoke (283) facing the core (273) of the stator (270) is formed with the magnet (286). The rotor (280) and the rotation shaft (260) are rotated by a magnetic field generated by the coil (276) wound on the core (273) which is a part of the stator (270) and action of the magnet (286) which is a part of the rotor (280).

FIG. 5 is an exploded perspective view illustrating a stepping motor coupled to the base unit of FIG. 3.

Referring to FIGS. 3 and 5, the stepping motor (300) is coupled to the first and second fixtures (142, 146) of the second motor fixture (140) of the base unit (100), where the stepping motor (300) includes a stepping motor body (310), a lead screw (320), and a pivot member (325).

The stepping motor body (310) includes a stator (not shown), and the lead screw (320) is rotated in association with the stator. In the present exemplary embodiment, the stepping motor body (310) and the lead screw (320) may include various configurations, such that the configuration of the stepping motor body is not limited thereto. The lead screw (320) is formed toward a radial direction of an optical disk (not shown) secured at the disk fixture device (220) of the spindle motor (200).

One lateral surface of the lead screw (320) is rotatably supported by the first fixture (142) via through hole (144) of the first fixture (142) of the second motor fixture (140), and the other lateral surface facing the one lateral surface of the lead screw (320) is inserted into the insertion groove (147) of the second fixture (146) at the second motor fixture (140) to be rotatably supported by the second fixture (146).

The pivot member (325) is coupled to the other lateral unit of the lead screw (320) and secured to the insertion groove (147) of the second fixture (146) at the second motor fixture (140). The pivot member (320) may include a clip unit that is press-fitted to the second fixture (146) perpendicularly bent to the upper plate (110) of the base unit (100).

Referring to FIGS. 1 and 5 again, the integrated disk driving module (700) according to an exemplary embodiment of the present disclosure may include an optical pickup module (400).

The optical pickup module (400) reciprocates along a radial direction of the disk by the lead screw (320) of the stepping motor (300) secured to the upper plate (110) of the base unit (100) by a coupling screw, and first and second guide shafts (410, 420) arranged in parallel with the lead screw (320).

The first guide shaft (410) is slidably coupled to one side of the optical pickup module (400), and includes a first distal end (411) and a second distal end (412) opposite to the first distal end (411). The first and second distal ends (411, 412) of the first guide shaft (410) are respectively coupled to the pair of first guide shaft fixtures (150).

The second guide shaft (420) is slidably coupled to the other side opposite to the one side of the optical pickup module (400), and includes a third distal end (421) and a fourth distal end (421) opposite to the third distal end (421). The third and fourth distal ends (421, 422) of the second guide shaft (420) are respectively coupled to the pair of second guide shaft fixtures (160).

Referring to FIG. 1 again, the first distal end (411) of the first guide shaft (410) is arranged with a first pressure member (340) to inhibit the first and second distal ends (411, 412) of the first guide shaft (410) from being disengaged, and a second pressure member (347) is arranged at the second distal end (412).

The third distal end (421) of the second guide shaft (420) is arranged with a third pressure member (348) to inhibit the third and fourth distal ends (421, 422) of the first guide shaft (420) from being disengaged, and a fourth pressure member (349) is arranged at the fourth distal end (422).

Each of the first to fourth pressure members (340, 347, 348, 349) takes the shape of a leaf spring, each distal end of one each side of the first to fourth pressure members (340, 347, 348, 349) is secured at the upper plate (110), and each other distal end facing the each one side of the first to fourth pressure members (340, 347, 348, 349) applies pressure to the first to fourth distal ends (411, 412, 421, 422).

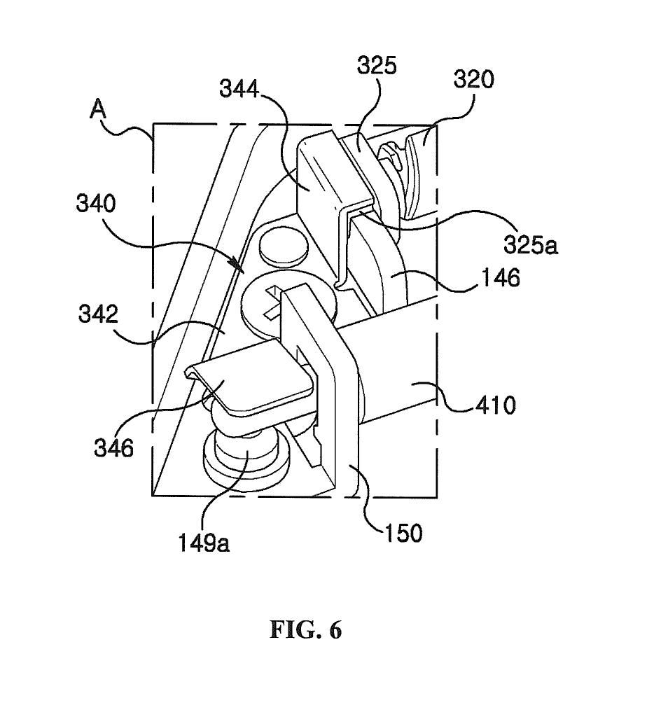

FIG. 6 is a partial enlarged view of ‘A’ of FIG. 1.

Referring to FIGS. 1 and 6, the pivot member (325) secured at the second fixture (146) of the second motor fixture (140), and the first distal end (411) of the first guide shaft (410) coupled to the first guide shaft fixture (150) are adjacently arranged, whereby the pivot member (325) and the first distal end (411) can be simultaneously applied with pressure by one pressure member (340) in the present exemplary embodiment.

To this end, the pressure member (340) in the present disclosure may include a body (342), a first pressure unit (344) and a second pressure unit (346).

The body (342) takes the shape of a plate and is secured to the upper plate (110) of the base unit (100) via a coupling screw, the first pressure unit (344) is extended and bent from the body (342) to apply pressure to the pivot member (325), and the second pressure unit (346) is extended and bent from the body (342) to apply pressure to the first distal end (411) of the first guide shaft (410).

As apparent from the foregoing, the integrated disk driving module according to the present disclosure has an advantageous effect in that a base unit is formed with a recess-shaped first motor fixture for mounting a spindle motor to a base unit and a second motor fixture for mounting a lead screw of a stepping motor, the first motor fixture is mounted with the spindle motor and the second motor fixture is mounted with the lead screw coupled to the stepping motor, to reduce the number of parts of the integrated disk driving module, to reduce assembly time as a result of reduced number of parts, to improve product performance as a result of reduced assembly tolerances, to inhibit incomplete assembly and to reduce size and weight by arranging the spindle motor and the stepping motor at designated positions.

Although embodiments have been described with reference to a number of illustrative embodiments thereof, it should be understood that numerous other modifications and embodiments can be devised by those skilled in the art that will fall within the spirit and scope of the principles of this invention. More particularly, various variations and modifications are possible in the component parts and/or arrangements of the subject combination arrangement within the scope of the disclosure, the drawing and the appended claims. In addition to variations and modifications in the component parts and/or arrangements, alternative uses will also be apparent to those skilled in the art.

What is claimed is:

1. An integrated disk driving module, the module comprising: a base unit including a first motor fixture concavely formed on an upper plate, and a second motor fixture bent from the upper plate in opposition to the first motor fixture, wherein the first and second motor fixtures are integrally formed on the upper plate; a spindle motor secured inside the first motor fixture to rotate a disk; and a stepping motor rotatably secured to the second motor fixture.

2. The integrated disk driving module of claim 1, wherein the unit base includes a lateral surface plate bent from an edge of the upper plate to form an accommodation space by the upper plate and the lateral surface plate.

3. The integrated disk driving module of claim 2, wherein the first motor fixture integrally formed on the upper plate includes a lateral wall unit bent from the upper plate, and a floor unit connected to the lateral wall unit.

4. The integrated disk driving module of claim 3, further comprising a circuit substrate interposed between the spindle motor and the floor unit to be electrically connected to the spindle motor, wherein the lateral wall unit is formed with at least one opening passing part of the circuit substrate.

5. The integrated disk driving module of claim 4, wherein the opening is formed in plurality, each opening having a different size.

6. The integrated disk driving module of claim 4, wherein the floor unit is formed with at least one circuit substrate alignment hole passing the floor unit for aligning the circuit substrate on a designated position of the floor unit.

7. The integrated disk driving module of claim 4, wherein the circuit substrate is a flexible printed circuit substrate.

8. The integrated disk driving module of claim 3, wherein the floor unit takes the shape corresponding to that of the spindle motor when viewed on a plane.

9. The integrated disk driving module of claim 3, wherein a through hole is formed at a center of the floor unit of the upper plate, and the through hole of the floor unit is coupled to a bearing housing of the spindle motor.

10. The integrated disk driving module of claim 9, wherein an internal rotation prevention groove is concavely formed from an inner lateral surface formed by the through hole of the floor unit for preventing the spindle motor from rotating relative to the floor unit.

11. The integrated disk driving module of claim 3, wherein the center of the floor unit is formed with a burring unit protruded from the bottom surface of the floor unit toward an upper surface opposite to the bottom surface, wherein the spindle motor includes a cup-shaped bearing housing coupled to the burring unit, a bearing coupled to an inside of the bearing housing, a rotation shaft rotatably coupled to the bearing, a stator coupled to the bearing housing, and a rotor coupled to the rotation shaft to interact with the stator.

12. The integrated disk driving module of claim 1, wherein a pair of second motor fixtures bent from the upper plate includes a first fixture rotatably supporting one lateral unit of a lead screw of the stepping motor, and a second fixture rotatably supporting the other lateral unit opposite to the one lateral unit of the lead screw.

13. The integrated disk driving module of claim 12, wherein the first fixture is formed with a through hole through which the one lateral unit of the lead screw passes, and the second fixture is formed with an insertion groove into which a periphery of the other lateral unit of the lead screw.

14. The integrated disk driving module of claim 13, wherein the other lateral unit of the lead screw inserted into the insertion groove is formed with a pivot unit.

15. The integrated disk driving module of claim 14, wherein the pivot unit includes a clip unit fixed by being inserted into the insertion groove.

16. The integrated disk driving module of claim 1, further comprising an optical pickup module that is fed by the stepping motor along a radial direction of the disk.

17. The integrated disk driving module of claim 16, wherein the upper plate includes a first guide shaft securing a first guide shaft for guiding the optical pickup module, and a second guide shaft fixture securing a second guide shaft arrange in parallel with the first guide shaft

18. The integrated disk driving module of claim 17, wherein the first guide shaft fixture is bent from the upper plate to allow each protruder protruded from both distal ends of the first guide shaft to be inserted, and the second guide shaft fixture is bent from the upper plate to allow each protruder protruded from both distal ends of the second guide shaft to be inserted.

19. The integrated disk driving module of claim 18, wherein the protruders protruded from the both distal ends of the first guide shaft and the protruders protruded from the both distal ends of the second guide shaft are respectively coupled by pressure members.

20. The integrated disk driving module of claim 19, wherein the upper plate corresponding to the protruders of the first and second guide shafts is coupled with a height adjustment screw for adjusting each height of the first and second guide shafts.
